(19) United States
(12) Patent Application Publication
(10) Pub. No.: US 2015/0367262 A1
(43) Pub. Date: Dec. 24, 2015

(54) SEEPAGE FILTER AND METHOD OF MANUFACTURING THE SAME

(71) Applicant: Li Chun HO, Taichung City (TW)

(72) Inventor: Li Chun HO, Taichung City (TW)

(21) Appl. No.: 14/614,225

(22) Filed: Feb. 4, 2015

(30) Foreign Application Priority Data
Jun. 23, 2014 (TW) 103211089

(51) Int. Cl. B01D 35/04; B22D 23/06; B01D 29/00; B01D 39/20; B01D 35/30

(52) U.S. Cl. CPC B01D 35/04; B01D 39/2034; B01D 35/306; B01D 29/0093; B22D 23/06

(57) ABSTRACT

A seepage filter adapted for mounting to an outflow device includes a connection body and a filtering member. The connection body includes an inlet for connecting to the outflow device, an outlet distanced from the inlet, and a connection portion which is near the inlet, disposed on outer or inner circumferential surface and adapted for connectable with the outflow device. The filtering member is coveringly attached to the outlet of the connection body, and includes metal particles integrally connected with each other, and filtering pores which form among the metal particles, extend non-linearly and communicate the outlet and an outside. The filtering member is manufactured through disposing the metal particles in a shaping mold and heating the metal particles to meltably connect the metal particles with each other.

### BACKGROUND OF THE INVENTION

1. Field of the Invention

The present invention relates to a seepage filter and a method of manufacturing the same.

2. Description of the Prior Art

Usually, water used in a home is pumped up into a reservoir on top of the building and then flows down to the faucets for use. However, if the water conduit is not designed well and the water pressure is not adequately lowered down, the water flow comes out from the faucet with a over high flow velocity so that the water will splashes everywhere, is uncomfortable for hands, and cannot be formed continuously on an object to be washed so that the washing effect is poor.

As shown in FIG. 1, to solve the above-mentioned problem, a conventional filter 11 for mounting to an outflow device 10 is usually a filtering foam rubber 12 made from plastic, for filtering the water. However, the conventional tilted 1 made from plastic will degrade easily after a long-time use, and will be expanded to be irreversibly deformed and loosened due to the water pressure, and thus resulting in a unsteady water stream and malfunction of filtering.

The present invention is, therefore, arisen to obviate or at least mitigate the above-mentioned disadvantages.

### SUMMARY OF THE INVENTION

The main object of the present invention is to provide a seepage filter from which water can gently seepage out, and the seepage filter has good filtering effect.

To achieve the above and other objects, the present invention provides a seepage filter. The seepage filter includes a connection body and a filtering member. The connection body includes an outer circumferential surface, an inner circumferential surface distanced from the outer circumferential surface, an inlet for connecting to the outflow device, an outlet distanced from the inlet, and a connection portion which is near the inlet, disposed on one of the outer circumferential surface and the inner circumferential surface and adapted for connecting with the outflow device. The filtering member is coveringly attached to the outlet of the connection body and includes a plurality of metal particles integrally connected with each other. A plurality of filtering pores form among the metal particles and extend non-linearly and communicate the outlet and an outside.

To achieve the above and other objects, the present invention further provides a method of manufacturing a seepage filter. The method includes the steps of: providing a connection body, the connection body including an outer circumferential surface, an inner circumferential surface distanced from the outer circumferential surface, an inlet for connecting to the outflow device, an outlet distanced from the inlet, and a connection portion which is near the inlet, disposed on one of the outer circumferential surface and the inner circumferential surface and adapted for connecting with the outflow device; and providing a plurality of metal particles, meltably connecting the metal particles with each other to form a filtering member, wherein a plurality of filtering pores are formed among the metal particles, the filtering pores extend non-linearly and communicate the outlet and an outside; coveringly attaching the filtering member to the outlet of the connection body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a drawing showing a conventional filter;

FIG. 2 is a perspective view according to a preferable embodiment of the present invention;

FIG. 3 is a cross-sectional view according to a preferable embodiment of the present invention;

FIGS. 4-8 are drawings showing applications of the seepage filter according to various preferable embodiments of the present invention;

FIG. 9 is a cross-sectional view according to a second preferable embodiment of the present invention;

FIG. 10 is a drawing showing an application of the seepage filter according to the second preferable embodiment of the present invention; and

FIGS. 11-14 are drawings showing a method of manufacturing a seepage filter according to a preferable embodiment of the present invention.

### DETAILED DESCRIPTION OF THE PREFERRED EMBODIMENTS

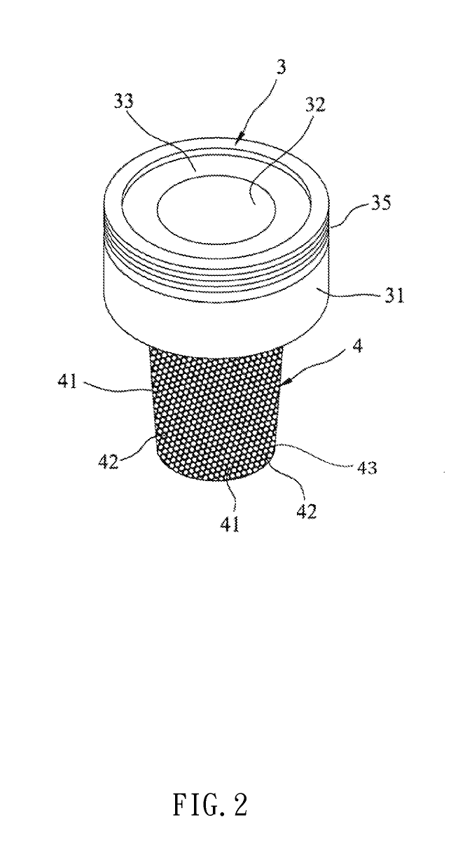

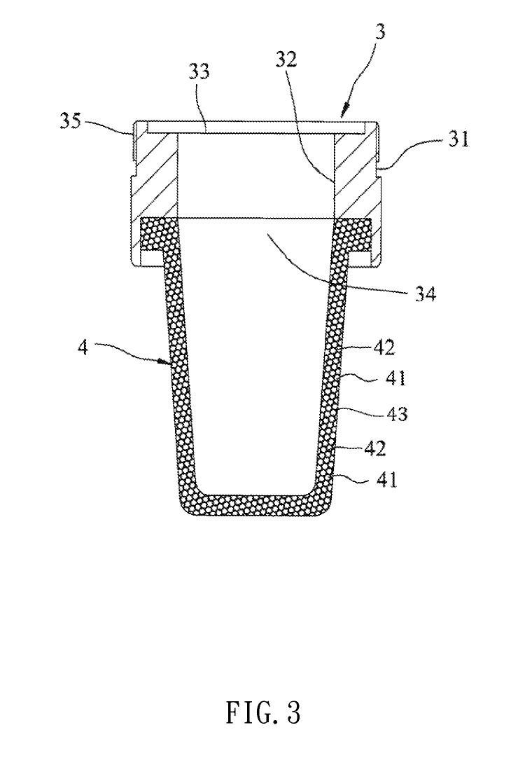

Please refer to FIGS. 2 to 4 for a preferable embodiment of the present invention.

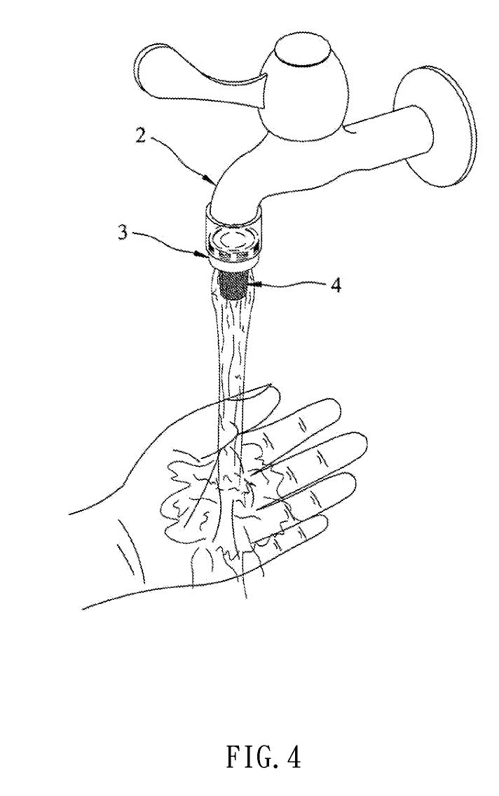

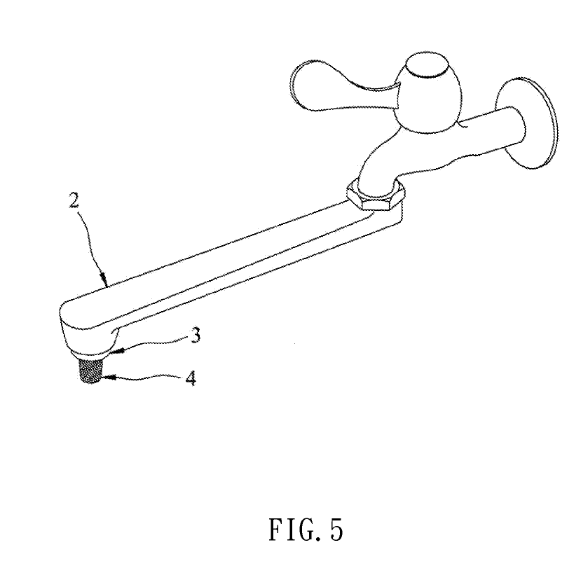

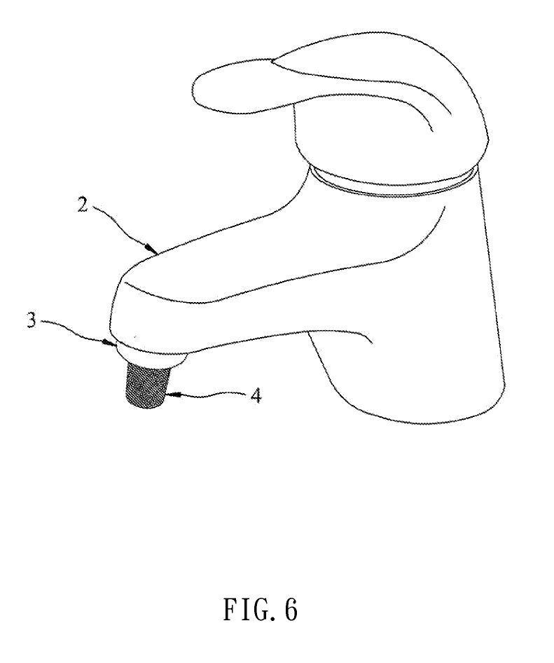

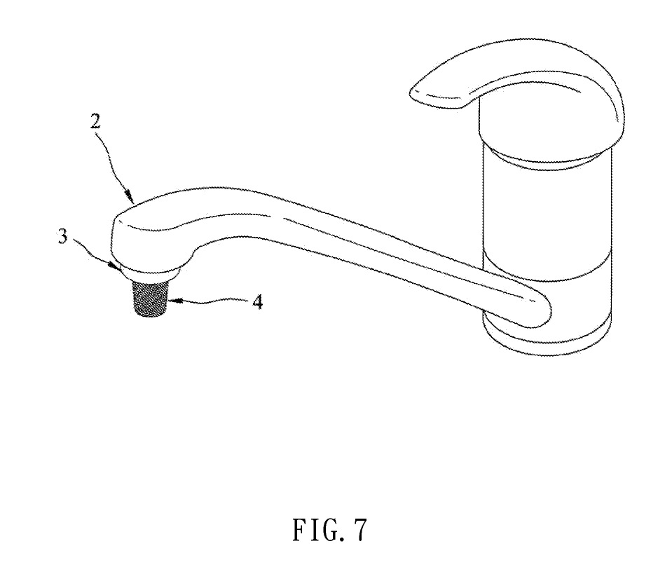

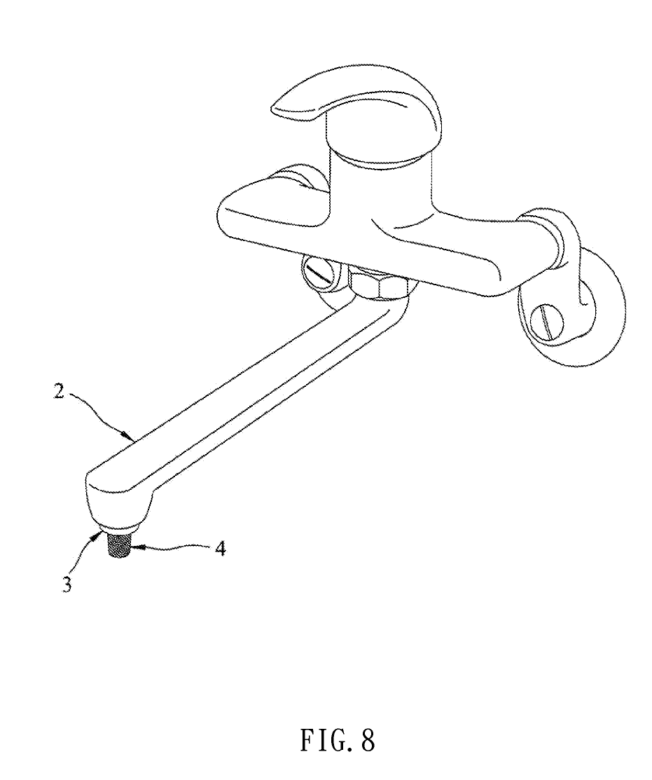

A seepage filter is adapted for mounting to an outflow device 2 and includes a connection body 3 and a filtering member 4. FIGS. 4 to 8 show different embodiments.

The connection body 3 including an outer circumferential surface 31, an inner circumferential surface 32 distanced from the outer circumferential surface 31, an inlet 33 for connecting to the outflow device 2, an outlet 34 distanced from the inlet 33, and a connection portion 35 which is near the inlet 33, disposed on one of the outer circumferential surface 31 and the inner circumferential surface 32 and adapted for connecting with the outflow device 2.

In this embodiment, the connection portion 35 is provided as an outer thread formed on the outer circumferential surface 31, for threadedly connecting with the outflow device 2. The connection portion 35 may be provided as an inner thread formed on the inner circumferential surface 32. The connection portion 35 may be connecting with the outflow device 2 via a mechanism such as, but not limited to, engagement, buckle structures, or the like disposed correspondingly on the outer circumferential surface 31 and the inner circumferential surface 32 respectively.

The filtering member 4 is preferably cup-shaped and coveringly attached to the outlet 34 of the connection body 3. The filtering member 4 includes a plurality of metal particles 41 integrally connected with each other, and a plurality of filtering pores 42 which form among the metal particles 41, extend non-linearly and communicate the outlet 34 and an outside.

The cup-shaped the filtering member 4 can increase the amount of the filtering pores 42, so that the seepage filter can allow large amount of water to pass through when mounted to the outflow device 2 having a large flow rate, so as to provide a large amount of water outflow, thus achieving good washing efficiency and being comfortable for use. As shown in FIG. 4, when the outflow device 2 has a large flow rate, the water can gently seepage out from the cup-shaped filtering member 4 and is guided to become a downward stream without air bubbles existing therewin, thus avoid splash of water.

In this embodiment, the connection body 3 and the filtering member 4 are made of brass. The metal particles 41 of the filtering member 4 are integrally connected with each other through sintering, for example. The outer surface of the filtering member 4 may be processed by electroplating according to various requirements. The connection body 3 and the filtering member 4 may be made of stainless steel and connected with each other by diffusion bonding, for example. An outer diameter of the metal particle 41 is preferably between 40-140 μm, such as 40 μm, 70 μm, 100 μm, or 140 μm; however, the outer diameter of the metal particle 41 may be selectively different according to a different flow rate, or the metal particles 41 may includes various outer diameters in combination.

The metal particles 41 are integrally connected with each other preferably by a meltable connection material 43. The meltable connection material 43 may be tin, zinc or nickel. For example, the metal particle 41 is a bronze particle, and the meltable connection material 43 is tin. The bronze particle includes copper preferably of at least 85 wt %, and the bronze particle includes tin of 10 wt %. Alternatively, the metal particle 41 may be a brass particle, and the meltable connection material 43 is zinc. The brass particle includes copper preferably of 58-62 wt %, and the brass particle includes zinc preferably of 10 wt %. The metal particles 41 may be a stainless steel (such as SUS 316L or the like) particle, and the meltable connection material 43 is nickel. The stainless steel particle includes nickel preferably of 12-15 wt %. It is noted that other metal particle and connection material having properties like those of the metal particle 41 and the meltable connection material 43 may be used in various embodiments. In addition, the filtering member may be provided with any suitable shape.

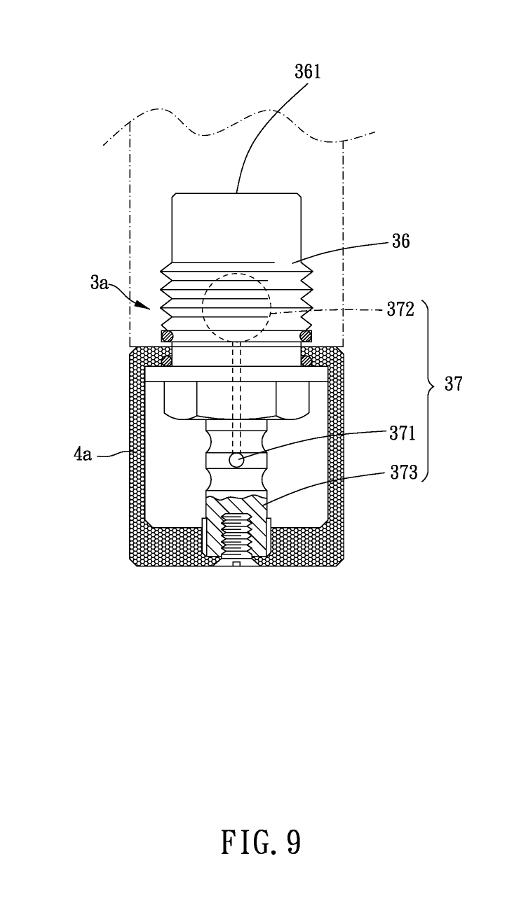

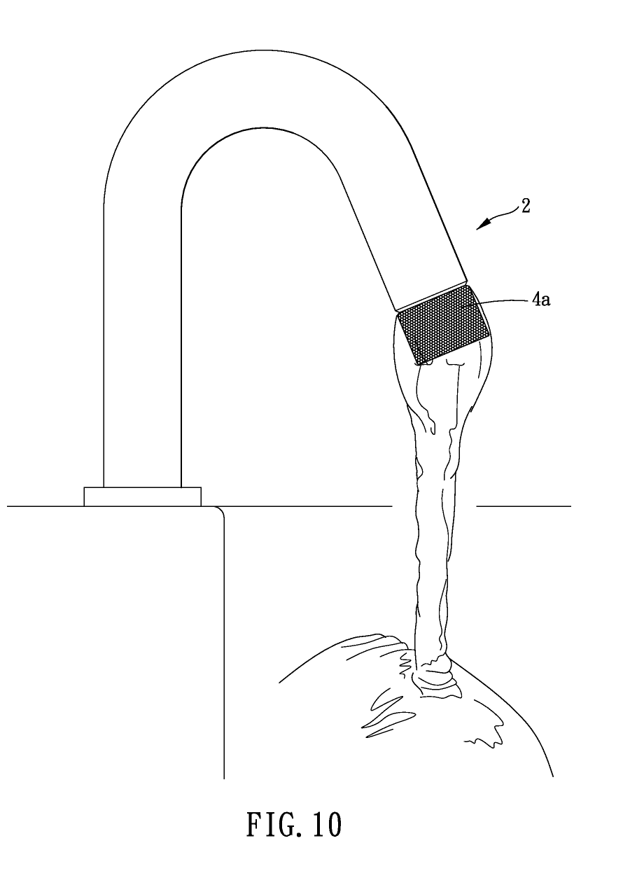

Please referring further to FIGS. 9 and 10, a connection body 3a including a shell body 36 and a tubular vale assembly 37 rotatably connected to the shell body 36. The shell body 36 is provided with a inlet 361, and the tubular vale assembly 37 includes at least one passageway 371, a vale body 372 sealingly assembled in the shell body 36 and a rotary member 373 extending from the vale body 372 to outside the shell body 36. Each passageway 371 extends from the vale body 372 to the rotary member 373 and one end thereof is opened at an outer surface of the rotary member 373, and a distal end of the rotary member 373 is closed. A filtering member 4a is fixedly connected with the distal end of the rotary member 373 and disposed around the rotary member 373. The filtering member 4a is sealingly rotatably connected with the shell body 36. The filtering member 4a is rotatable to drive the rotary member 373 to rotate the vale body 372 so as to selectively communicate the inlet 361 and an interior of the filtering member 4a via the at least one passageway 371. In this embodiment, the filtering member 4a detachably connected with the distal end of the rotary member 373 using a threaded member. The seepage filter can also serve as an open/close mechanism, has a simple structure, and is of low cost. Furthermore, after use of cleaning agent to clean hands, cleaning agent on the hands will reside on the filtering member 4a as the outflow device is turned to open, and the cleaning agent residing on the filtering member 4a can be washed away by water seeping out from the filtering pores automatically. As a result, user needs not hold water to wash the outflow device, and thus it is very hygienic and convenient.

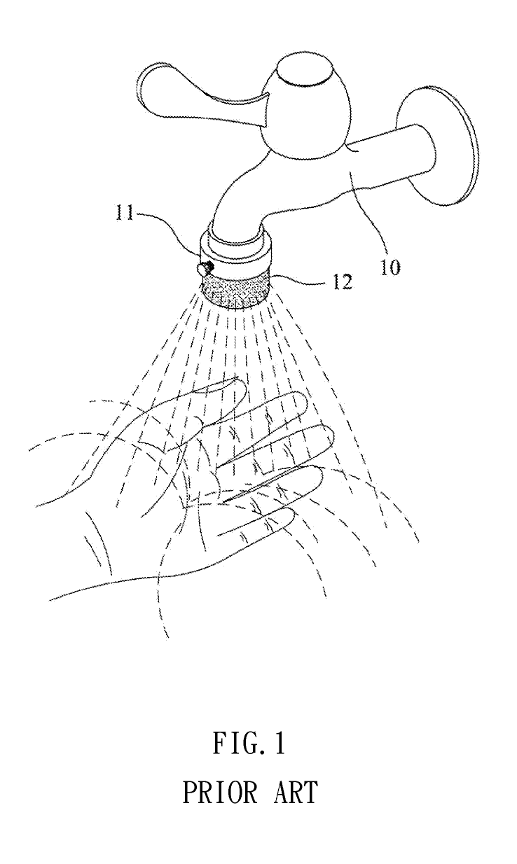

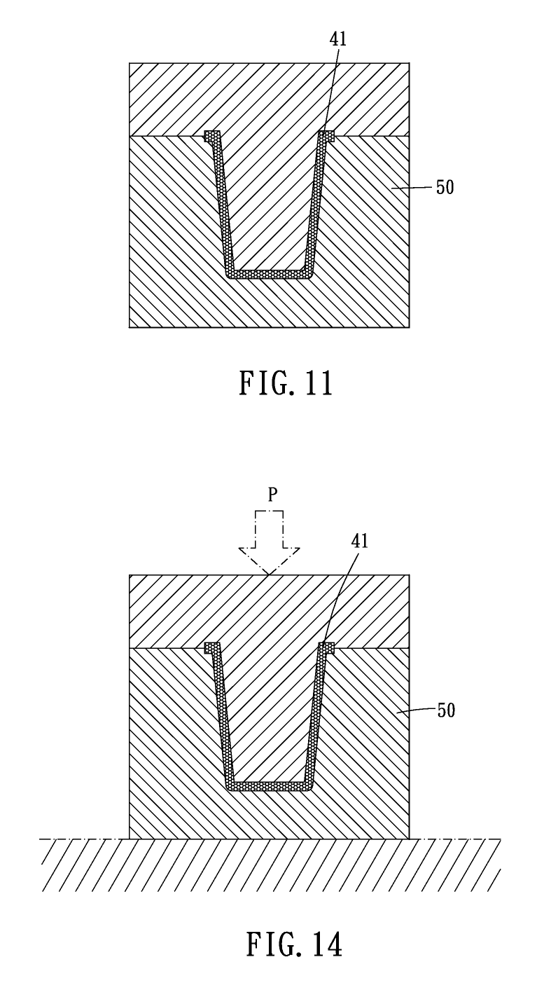

A method of manufacturing the seepage filter is further provided. Please further referring to FIGS. 1-3 and 11-14, the method includes steps of: providing a connection body 3, the connection body 3 including an outer circumferential surface 31, an inner circumferential surface 32 distanced from the outer circumferential surface 31, an inlet 33 for connecting to the outflow device 2, an outlet 34 distanced from the inlet 33, and a connection portion 35 which is near the inlet 33, disposed on one of the outer circumferential surface 31 and the inner circumferential surface 32 and adapted for connecting with the outflow device 2; providing a plurality of metal particles 41, meltably connecting the metal particles 41 with each other to form a filtering member 4, wherein a plurality of filtering pores 42 are formed among the metal particles 41, the filtering pores 42 extend non-linearly and communicate the outlet 34 and an outside; coveringly attaching the filtering member 4 to the outlet 34 of the connection body 3.

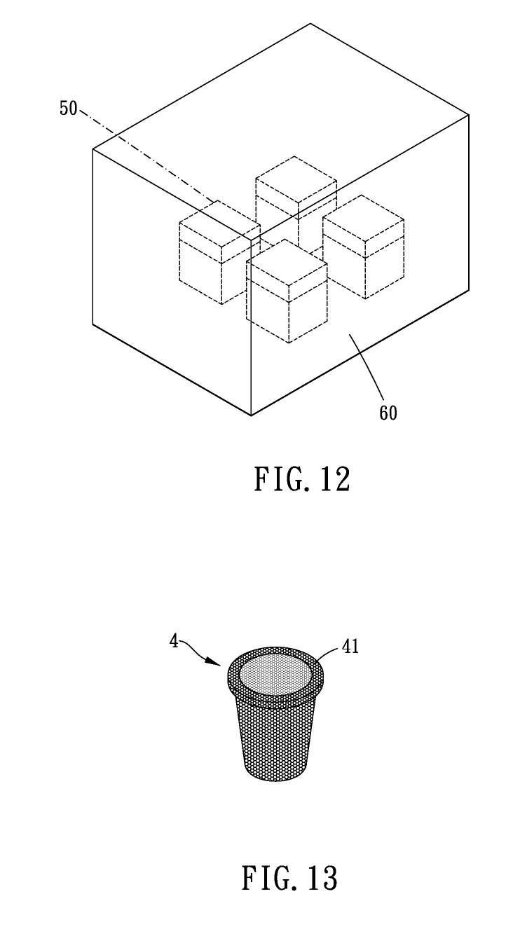

A process of manufacturing the filtering member 4 includes steps of: using bronze or brass particles as the metal particles 41, and disposing the metal particles 41 in a shaping mold 50; heating the metal particles 41 with a temperature of 850-900° C. to meltably connect the metal particles 41 with each other to form the filtering member 4. Preferably, the metal particles 41 are heated (such as a sintering process) in a substantial vacuum condition 60 and with a mixture gas including hydrogen of 25% and nitrogen of 75% added into the substantial vacuum condition 60 (as shown in FIG. 12). During heating of the metal particles 41, the hydrogen can activate bronze or brass and prevent bronze or brass from oxidation, darkening, peeling (such as verdigris), and the nitrogen can avoid explosion.

In an alternative embodiment, a process of manufacturing the filtering member 4 includes steps of: using stainless steel particles as the metal particles 41, and disposing the metal particles 41 in a shaping mold 50; exerting a pressure P of 2 ton/cm² on and heating the metal particles 41 (as shown in FIG. 14) with a temperature of 850-900° C. to meltably connect the metal particles 41 with each other to form the filtering member 4.

Through the above-mentioned structure, the seepage filter has the following advantages and effects:

The non-linearly-extending filtering pores 42 can allow water to seepage out gently and lower its flow velocity and impact. Moreover, the seeping-out water is guided to become a downward stream without air bubbles existing therewin, and a thin water layer can be formed continuously on an object to be washed so that the washing effect is good and splash of water can be avoided, and it is comfortable for hands.

Since the connection body 3 and the filtering member 4 are made of metal, the seepage filter is durable, detachable and easy to be cleaned by brushing or back washing, and reusable and environment-friendly.

Compared to the conventional structure, in the invention, the metal particles 41 are meltedly connected with each other, the filtering pores 42 will not degrades after used for a long time, thus able to provide steady gentle water stream.

Given the above, through the non-linearly extending filtering pores 42, water can gently seepage out from the seepage filter even with a great flow rate of water, and the seepage filter has good filtering effect. Additionally, the seepage filter can also serve as an open/close mechanism, has a simple structure, and is of low cost. Furthermore, after use of cleaning agent to clean hands, cleaning agent on the hands will reside on the filtering member 4a as the outflow device is turned to open, and the cleaning agent residing on the filtering member 4a can be washed away by water seeping out from the filtering pores automatically.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A seepage filter, adapted for mounting to an outflow device, including:
a connection body, including an outer circumferential surface, an inner circumferential surface distanced from the outer circumferential surface, an inlet for connecting to the outflow device, an outlet distanced from the inlet, and a connection portion which is near the inlet, disposed on one of the outer circumferential surface and the inner circumferential surface and adapted for connecting with the outflow device; and
a filtering member, coveringly attached to the outlet of the connection body, including a plurality of metal particles integrally connected with each other, and a plurality of filtering pores which form among the metal particles, extend non-linearly and communicate the outlet and an outside.

2. The seepage filter of claim 1, wherein the metal particles of the filtering member are meltedly connected with each other.

3. The seepage filter of claim 2, wherein an outer diameter of the metal particle is 40 μm, 70 μm, 100 μm or 140 μm.

4. The seepage filter of claim 2, wherein the metal particles are meltedly connected with each other by a meltable connection material.

5. The seepage filter of claim 4, wherein the meltable connection material is tin, zinc or nickel.

6. The seepage filter of claim 5, wherein the metal particle is a bronze particle, and the meltable connection material is tin.

7. The seepage filter of claim 6, wherein the bronze particle includes copper of at least 85 wt %, and the bronze particle includes tin of 10 wt %.

8. The seepage filter of claim 5, wherein the metal particle is a brass particle, and the meltable connection material is zinc.

9. The seepage filter of claim 8, wherein the brass particle includes copper of 58-62 wt %, and the brass particle includes zinc of 10 wt %.

10. The seepage filter of claim 5, wherein the metal particle is a stainless steel particle, and the meltable connection material is nickel.

11. The seepage filter of claim 10, wherein the stainless steel particle includes nickel of 12-15 wt %.

12. The seepage filter of claim 2, wherein the filtering member is cup-shaped and coveringly attached to the outlet of the connection body.

13. The seepage filter of claim 1, wherein the connection portion of the connection body is provided as an outer thread formed on the outer circumferential surface.

14. The seepage filter of claim 1, wherein the connection portion of the connection body is provided as an inner thread formed on the inner circumferential surface.

15. The seepage filter of claim 1, wherein the connection body and the filtering member are made of brass, bronze or stainless steel.

16. The seepage filter of claim 1, wherein the connection body includes a shell body and a tubular vale assembly rotatably connected to the shell body, the shell body is provided with the inlet, the tubular vale assembly includes at least one passageway, a vale body sealingly assembled in the shell body and a rotary member extending from the vale body to outside the shell body, each passageway extends from the vale body to the rotary member and one end thereof is opened at an outer surface of the rotary member, a distal end of the rotary member is closed, the filtering member is fixedly connected with the distal end of the rotary member and disposed around the rotary member, the filtering member is sealingly rotatably connected with the shell body, and the filtering member is rotatable to drive the rotary member to rotate the vale body so as to selectively communicate the inlet and an interior of the filtering member via the at least one passageway.

17. A method of manufacturing the seepage filter of claim 1, including the steps of:
providing a connection body, the connection body including an outer circumferential surface, an inner circumferential surface distanced from the outer circumferential surface, an inlet for connecting to the outflow device, an outlet distanced from the inlet, and a connection portion which is near the inlet, disposed on one of the outer circumferential surface and the inner circumferential surface and adapted for connecting with the outflow device; providing a plurality of metal particles, meltably connecting the metal particles with each other to form a filtering member, wherein a plurality of filtering pores are formed among the metal particles, the filtering pores extend non-linearly and communicate the outlet and an outside;
coveringly attaching the filtering member to the outlet of the connection body.

18. The method of claim 17, wherein a process of manufacturing the filtering member including steps of:
using bronze or brass particles as the metal particles, and disposing the metal particles in a shaping mold;
heating the metal particles with a temperature of 850-900° C. to meltably connect the metal particles with each other to form the filtering member.

19. The method of claim 18, wherein the metal particles are heated in a substantial vacuum condition and with a mixture gas including hydrogen of 25% and nitrogen of 75% added into the substantial vacuum condition.

20. The method of claim 17, wherein a process of manufacturing the filtering member including steps of:
using stainless steel particles as the metal particles, and disposing the metal particles in a shaping mold;
exerting a pressure of 2 ton/cm² on and heating the metal particles with a temperature of 850-900° C. to meltably connect the metal particles with each other to form the filtering member.
